(19) United States
(12) Patent Application Publication
(10) Pub. No.: US 2006/0012465 A1
(43) Pub. Date: Jan. 19, 2006

(54) Collision prevention method for RFID system and RFID system

(75) Inventors: Jae-Ho Lee, Gumi-si (KR); Yang-Gee Kang, Gumi-si (KR)

Correspondence Address: MAYER, BROWN, ROWE & MAW LLP, 1909 K STREET, N.W., WASHINGTON, DC, 20006, US

(73) Assignee: NESSLAB CO., LTD.

(21) Appl. No.: 11/235,203

(22) Filed: Sep. 27, 2005

(30) Foreign Application Priority Data
Aug. 20, 2005 (KR) 10-2005-0076567
Oct. 23, 2003 (KR) 2003-74130

(51) Int. Cl. H04Q 5/22

(52) U.S. Cl. 340/10.2; 342/42; 340/572.4; 340/10.34

(57) ABSTRACT

The present invention relates to a collision prevention method for a RFID system and a RFID system to minimize the collision of response signals by using sector antennas and controlling the power. The present invention comprises the steps of: separating plural tags in a space by setting up plural number of sector antennas; setting up the output stages of the power of each sector antenna to be increased in plural sequential stages; and reading a tag belonging to the output range by selecting a first sector antenna and transmitting minimum power among the set up stages. The present invention considerably reduce the collision probability of response signals of tags by dividing the tags in a space when a reader reads or writes tag information. The present invention also minimizes the time consumed to read/write tags and improves the communication distance and capacity.

### CROSS-REFERENCE TO RELATED APPLICATIONS

This application claims benefit under 35 U.S.C. § 119 from Korean Patent Application No. 2003-74130, filed on Oct. 23, 2003, the entire content of which is incorporated herein by reference.

### BACKGROUND OF THE INVENTION

1. Field of the Invention

The present invention relates to a collision prevention method for a RFID reader system and a RFID reader system. More specifically, the present invention relates to a collision prevention method and a RFID reader system to minimize the collision of response signals by using sector antennas and controlling the power.

2. Description of the Related Art

The RFID reader system is a system to, read information relating to the tag with a reader, and store various information corresponding to the tag after attaching characteristic tags to things, and is used for administration of physical distribution. The general RFID reader system comprises a tag (tag; 1), a reader (reader; 2) and a middleware (middleware; 3). The reader (2) among the constitutional elements comprises an antenna (2a), a RF part (2b) and a digital part (3c) (please refer to FIG. 1).

In the RFID reader system, the reader is called “a reader/write” since the reader not only recognizes the information of the tag, but also writes information on the tag, or is called “an interrogator” since the reader asks questions of the tag. Since the detection correctness or the recognition distance of the reader is influenced by the capacity of the antenna or environment, plural antennas may be used to improve the recognition capacity of the reader.

In the RFID reader system, the reader performs an essential function of tag information collection, and thus plays an important role in the success of the pertinent system along with the tag. Especially, whether the reader can correctly and promptly obtain information from the tag having various forms and constitutions greatly influences the reliability of the system.

Currently, most of the RFID reader system uses a half duplex system. Therefore, one antenna performs transmission and receipt of messages. And most of the readers of the RFID reader system use omnidirectional antennas, and thus when there are plural tags, collision of response signals occurs according to the probability that each tag responds simultaneously. Such collision of response signals deteriorates the capacity of readers, and decreases the speed of reading and writing tags.

It is anticipated that the RFID reader system will be used in various fields of collecting a large amount of information simultaneously, and thus it is requested to provide a reader, to which an algorithm for preventing collision of response signals is applied.

On the other hand, a system of using plural antennas is suggested as a way to solve the problem of the collision of response signals. This system reduces the possibility of collision of response signals by arranging omni-directional antennas to have a long distance between each other in a space (approximately within 4M), and selecting one antenna in each moment and outputting power. However, such a system is not free from the collision of response signals, as well.

### SUMMARY OF THE INVENTION

An object of the present invention is to minimize the probability of the collision of response signals in the operation of the RFID reader system. The present invention is to provide a collision prevention method for a RFID reader system and a RFID reader system completed to solve the technical task of preventing the collision of response signals of the tags, and improving communication distance and capacity by adopting a system of dividing a space by using plural sector antennas and controlling the power.

To achieve the above-described object, the collision prevention method comprising the steps of: separating plural tags in a space by setting up plural sector antennas; setting up the power of each sector antenna to be increased in plural sequential stages; selecting the first sector antenna and reading or writing tags belonging to the output range by transmitting with a minimum power among the set up stages; reading or writing tags belonging to each output range by transmitting while increasing the power of the first sector antenna in sequential stages; and repeating the same process for the rest of the sectors after completing the reading/writing of the tags belonging to the first sector.

### BRIEF DESCRIPTION OF THE DRAWINGS

The above aspects and features of the present invention will be more apparent by describing certain embodiments of the present invention with reference to the accompanying drawings, in which:

FIG. 1 is a schematic diagram of a general RFID reader system.

FIG. 2 is a reference drawing to explain the operation system of a sector antennas in accordance with the collision prevention method of the present invention.

FIG. 3 is a schematic diagram of a RFID reader system in accordance with the present invention.

FIG. 4 is a schematic diagram to explain a case where plural modulators/demodulators are assigned to plural sector antennas.

FIG. 5 is a schematic diagram to explain a case where one modulator/demodulator is assigned to plural sector antennas.

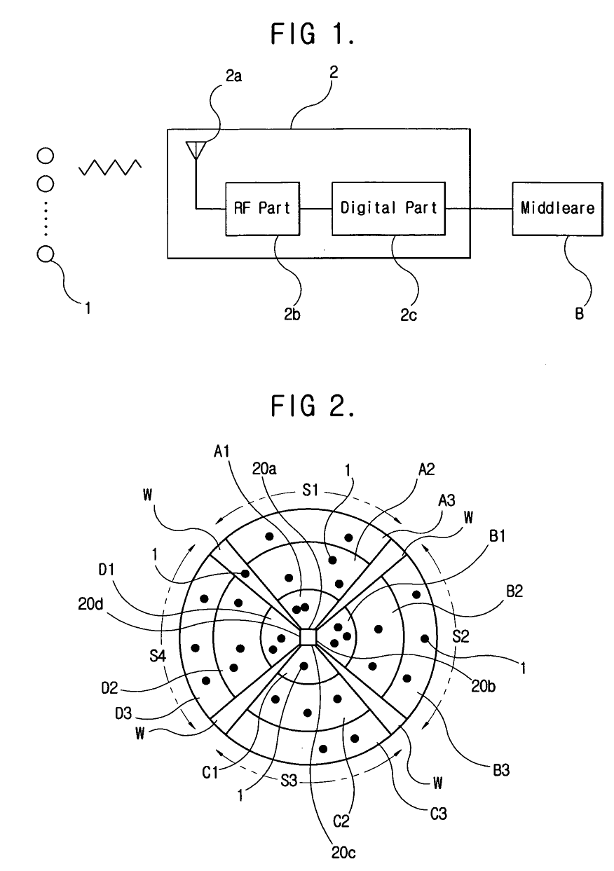

### DETAILED DESCRIPTION OF THE PREFERRED EMBODIMENTS

The collision prevention method for a RFID reader system presented by the present invention comprises a step of setting up sectors, a step of setting up the power, a step of selecting a sector and a step of reading or writing tags. A preferred embodiment of each step will be explained based on the operation system of the RFID reader system in accordance with the collision prevention method illustrated in FIG. 2.

First step—This step is to set up plural sectors by dividing the space where plural tags (1) exist. Plural sectors (S1,S2,S3,S4) are set up by installing plural sector antennas (20a,20b,20c,20d).

Here, it is desirable to form an overlap region (W) between the boundaries of sectors (S1,S2,S3,S4) to recognize a tag (1) located in adjacent areas of sectors (S1,S2,S3,S4) without a hitch.

Second step—This step is to set up the power. The output (detection signal) of each sector antenna (20a,20b,20c,20d) is set up to increase in plural sequential stages, and thereby the sector (S1,S2,S3,S4) belonging to a pertinent sector antenna (20a,20b,20c,20d) is divided again to sub-cells (A1/A2/A3, B1/B2/B3, C1/C2/C3, D1/D2/D3) according to the increase stage of the output.

Here, the power may be increased linearly or non-linearly. The linear increase means that the difference in the power (dB) is uniform, and the non-linear increase means that the output value of the power is decided to have the area of each sub-cell (A1/A2/A3, B1/B2/B3, C1/C2/C3, D1/D2/D3) belonging to a pertinent sector (S1,S2,S3,S4) be the same.

Third Step—This step is to select a sector (S1,S2,S3,S4) for which reading/writing is performed. An optional sector antenna (20a) is selected from plural sector antennas (20a, 20b, 20c, 20d), and then the output of the power for the selected sector antenna is prepared.

The fourth step—This step is to read or write a tag (1) belonging to the selected sector (S1). When power (detection signal) is output to the selected sector antenna (20a), a minimum power among the power set up at the sector antenna (20a) is transmitted to detect a tag (1) belonging to the pertinent output range (first sub-cell; A1) and have a reader read or write the tag (1). When reading/writing of the tag (1) belonging to the selected sub-cell (A1) is completed, the power is increased to the level of a higher-rank stage to have the reader read or write the tag belonging to the increased output range (a second sub-cell; A2). This step is repeated until the reading/writing of all the tags belonging to the sub-cells (A1/A2/A3) of the selected sector (S1) is completed. As described above, the number of sub-cells (A1/A2/A3) is decided by the output stages of the power.

Step 5—This step is to convert sector (S1). When the reading/writing of all the tags belonging to each output range (sub-cell; A1/A2/A3) of the selected sector (S1) is completed, the next sector antenna (20b) is selected and the process from the first step to the fourth step is repeated.

The present invention having the above constitution can reduce the probability of collision of response signals of tags (1) by dividing the space where tags (1) exist into plural sectors (S1,S2,S3,S4) by plural sector antennas (20a,20b,20c,20d); and again dividing the region of each sector (S1,S2,S3,S4) into plural output ranges (sub-cell; A1/A2/A3, B1/B2/B3, C1/C2/C3, D1/D2/D3) by constituting the output stage of the power of the sector antennas (20a,20b,20c,20d) to increase in regular sequence.

The above embodiment explains a collision prevention method for a RFID reader system using plural sector antennas and one RFID reader modem. According to the technical idea of the present invention, plural sector antennas and plural RFID reader modems (modulators/demodulators) corresponding thereto may be used. The collision prevention method for a RFID reader system by use of plural sector antennas and RFID reader modems is constituted as follows.

Plural sector antennas (20a,20b,20c,20d) and modems (modulators/demodulators) corresponding thereto are set up. Each sector (S1,S2,S3,S4) belonging to the sector antenna (20a,20b,20c,20d) is divided to sub-cells (A1/A2/A3, B1/B2/B3, C1/C2/C3, D1/D2/D3) according to the increase stage of the output by setting up the output range of the power of the sector antennas (20a,20b,20c,20d) to increase in plural sequential stages. When the power is output to each sector antenna (20a,20b,20c,20d), minimum power among the power set up at the sector antenna (20a,20b,20c,20d) is transmitted to read a tag (1) belonging to the output range (a first sub-cell; A1,B1,C1,D1). When reading and writing of the tag (1) belonging to the selected output range (a first sub-cell; A1,B1,C1,D1) is completed, the power is increased to a higher rank-stage to have the reader read or write tag (1) belonging to the pertinent output range (a second sub-cell; A2,B2,C2,D2). If more output ranges of the power exist, it can be constituted to have the reader read or write tags belonging to each pertinent output range (sub-cell) by increasing the power to higher-rank stages.

When the collision prevention method for a RFID system is constituted as shown above, the processes of reading the tags existing in the sub-cells (A1/A2/A3, B1/B2/B3, C1/C2/C3, D1/D2/D3) of each sector (S1,S2,S3,S4) are performed simultaneously and sequentially. Therefore, the reading/writing of each tag is more promptly completed.

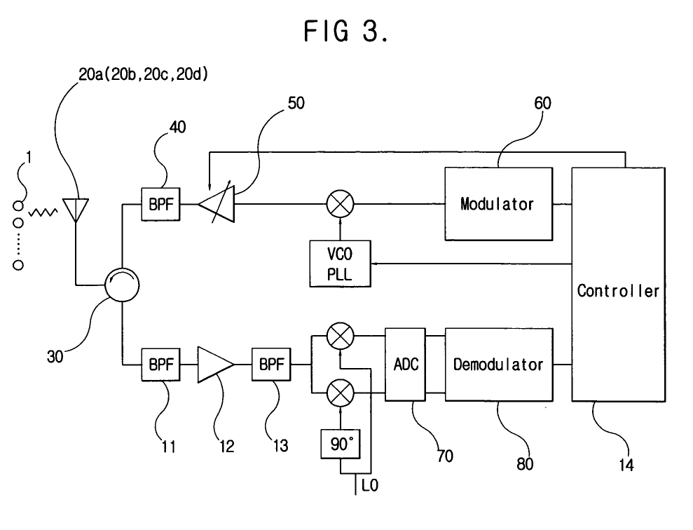

FIG. 3 illustrates a preferred embodiment of a RFID reader system (10) for realizing a collision prevention method. As illustrated therein, the present invention comprises plural sector antennas (20a,20b,20c,20d) for dividing the communication region where tags (1) exist to plural sectors (S1,S2,S3,S4); a circulator (30) for separating signals transmitted to and received from each sector antennas (20a,20b,20c,20d); a band limiting filter (13,40) for limiting the band of transmit/receive signals; a power control amp (50) for dividing the communication region (sector), which has been already divided by each sector antenna (20a,20b,20c,20d), to lower rank sub-cells (A1/A2/A3, B1/B2/B3, C1/C2/C3, D1/D2/D3) again by controlling the power (detection signal) output by each sector antenna (20a,20b,20c,20d); a modulator (60) for modulating the transmit signal; an AD converter (70) for converting an analog signal to a digital signal; and a demodulator (80) for embodying data demodulation and collision prevention algorithm.

In the RFID reader system (10) having the above constitution, the signal received from each sector antenna (20a,20b,20c,20d) is input to a receive band filter (11) through the circulator (30) and is amplified by a LNA (12). The amplified signal is filtered by the band limiting filter (13), and then is carrier demodulated to I-, Q-signal. The demodulated baseband analog signal is converted to a digital signal by an AD converter (70), and then is demodulated in the demodulator (80).

The controller (14) controls the PLL and frequency hopping pattern to produce a RF carrier signal, and also controls the output of the power control amp (50) for controlling the radius of the communication inside the sector (S1,S2,S3,S4) assigned to each sector antenna (20a,20b,20c,20d) by increasing the output of the power (detection signal) of each sector antenna (20a,20b,20c,20d) sequentially.

The data for transmission is encoded to desired signs in the modulator (60) and then is carrier modulated. The carrier modulated signal is amplified to a desired output in the power control amp (50), and then is filtered in the band limiting filter (40). The filtered signal is transmitted to each sector antenna (20a,20b,20c,20d) through a circulator (30). Each sector antenna (20a,20b,20c,20d) outputs the power (detection signal) according to the amplified output value.

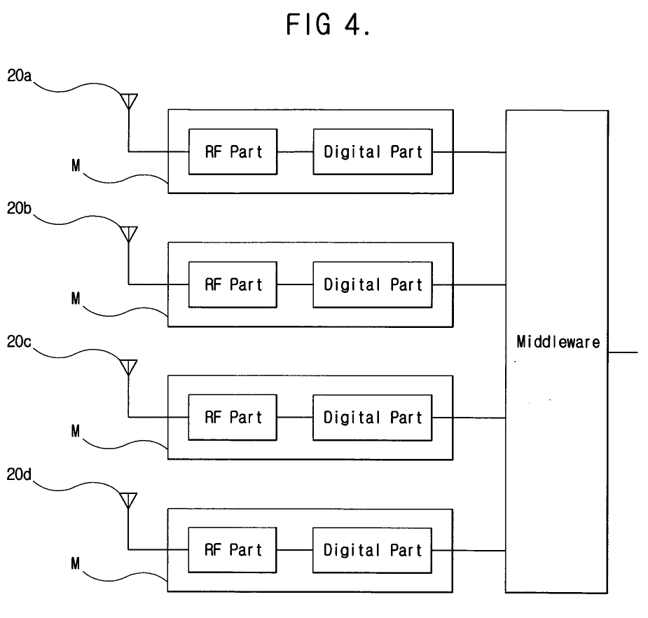

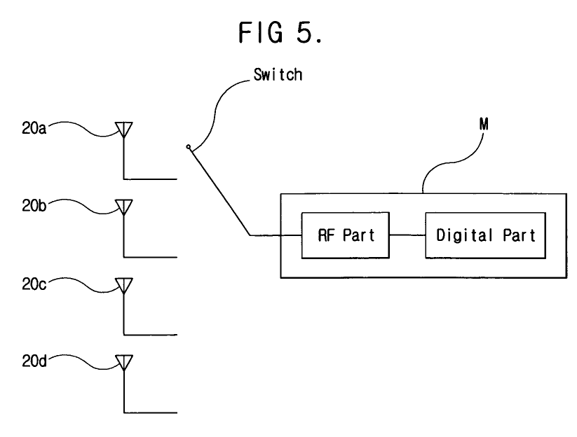

On the other hand, when plural sector antennas (20a,20b,20c,20d) are applied in the present invention, each sector antenna (20a,20b,20c,20d) may be assigned a modulator/demodulator (modem; M) corresponding thereto, respectively (please refer to FIG. 4), or one modulator/demodulator (modem; M) may be assigned to sector antennas (20a,20b,20c,20d) (please refer to FIG. 5). When a corresponding modulator/demodulator (M) is respectively assigned to each sector antenna (20a,20b,20c,20d), the processes of reading tags existing in each sector are performed simultaneously. And, when one modulator/demodulator (M) is assigned to sector antennas (20a,20b,20c,20d), the processes of reading tags belonging to each sector are performed simultaneously and sequentially, and the processes of reading tags in each sector are performed equally.

The collision prevention method for a RFID reader system and a RFID reader system presented by the present invention divides the tags in a space and increase the power to the divided sector by stages when having the reader read or write the tag information, and ultimately, reduces the probability of the collision of response signals of tags substantially and improves the reliability of the RFID reader system by multiple dividing the space where the tags exists. Also, the present invention not only minimizes the time consumed in reading and writing the tags, but also improves the communication distance and capacity. Likewise, the present invention has advantageous effects.

What is claimed is:

1. A collision prevention method for a RFID reader system wherein one modulator/demodulator (modem) is assigned to plural sector antennas, the comprising the steps of:
setting up the space where plural tags exist to be plural sectors by installing a plural number (N) of sector antennas in the space where plural tags exist;
dividing the sector belonging to a pertinent sector antenna to sub-cells according to the increase stage by setting up the output range of the power of each sector antenna to be increased in plural sequential stages;
preparing the output of the power by selecting an optional sector antenna as a first sector antenna among the plural sector antennas;
having a tag belonging to the output range (a first sub-cell) be read or written by transmitting a minimum power among the power set up at the sector antenna when outputting the power to the selected sector antenna, enabling the reader to read or write the tags belonging to the pertinent output range (a second sub-cell) by increasing the power to a higher rank stage after the reading and writing of the tags belonging to the selected output range (a first sub-cell) is completed, and enabling the reader to read or write the tags belonging to each of the pertinent output ranges (sub-cells) by increasing the power to higher rank stages if there exist more output ranges (sub-cells) of the power; and
selecting the next sector antenna and repeating the foregoing steps again when the reading/writing of all the tags belonging to the output ranges of the first sector is completed.

2. The collision prevention method according to claim 1, wherein the output range of the power of the sector antenna is constituted to be increased by a uniform power difference by a linear increase method, or the output range of the power of the sector antenna is decided to have the areas of all the sub-cells be the same by a non-linear increase method

3. A collision prevention method for a RFID reader system wherein plural sector antennas are assigned plural modulators/demodulators (modems) corresponding thereto, the method comprising the steps of:
dividing the sector belonging to a sector antenna to sub-cells according to the increase stage by setting up the output range of the power of each sector antenna to be increased in plural sequential stages; and
having a tag belonging to the output range (a first sub-cell) be read or written by transmitting a minimum power among the power set up at the sector antenna when outputting the power to the selected sector antenna, enabling the reader to read or write the tags belonging to the pertinent output range (a second sub-cell) by increasing the power to a higher rank stage after the reading and writing of the tags belonging to the selected output range (a first sub-cell) is completed, and enabling the reader to read or write the tags belonging to each of the pertinent output ranges (sub-cells) by increasing the power to higher rank stages if there exist more output ranges (sub-cells) of the power

4. The collision prevention method according to claim 3, wherein the output range of the power of the sector antenna is constituted to be increased by a uniform power difference by a linear increase method, or the output range of the power of the sector antenna is decided to have the areas of all the sub-cells be the same by a non-linear increase method

5. A RFID reader system for collision prevention which comprises a tag, a reader and a middleware, the system comprising:
a plurality of sector antennas (20a,20b,20c,20d) for dividing the space (communication region) where tags exist to plural sectors (S1,S2,S3,S4);
a circulator (30) for separating signals transmitted to and received from each sector antenna (20a,20b,20c,20d);
a band limiting filter (13, 40) for limiting the band of transmit and receive signals;
a power control amp (50) for dividing the sector (S1,S2,S3,S4) to lower rank sub-cells (A1/A21A3, B1/B2/B3, C1/C2/C3, D1/D2/D3) again by controlling the power of each sector antenna (20a,20b,20c,20d);
a converter (60) for converting the transmit signal;
an AD converter (70) for converting a baseband analog signal to a digital signal; and
a demodulator (80) for demodulating data and realizing collision prevention algorithm

6. The RFID reader system for collision prevention according to claim 5, wherein the sector antenna (20a,20b,20c,20d) for dividing the space where the tags (1) exist to plural sectors is a directional antenna or an array antenna.
